(19) United States
(12) Patent Application Publication
(10) Pub. No.: US 2013/0079744 A1
(43) Pub. Date: Mar. 28, 2013

(54) DRUG SOLUTION DELIVERY DEVICE FOR MEDICAL USE

(71) Applicants: Tadashi Okiyama, Hiroshima (JP); Hitoshi Tachizaki, Hiroshima (JP)

(72) Inventors: Tadashi Okiyama, Hiroshima (JP); Hitoshi Tachizaki, Hiroshima (JP)

(73) Assignee: JMS CO., LTD., Hiroshima-shi, Hiroshima (JP)

(21) Appl. No.: 13/702,235

(22) PCT Filed: Jun. 24, 2011
(86) PCT No.: PCT/JP2011/064574

§ 371 Date: Dec. 5, 2012

(30) Foreign Application Priority Data
Jul. 12, 2010 (JP) 2010-157976
Nov. 2, 2010 (JP) 2010-246110

(51) Int. Cl. A61J 1/20; A61J 1/14

(52) U.S. Cl. CPC A61J 1/2096; A61J 1/1406
USPC 604/408

(57) ABSTRACT

A cylindrical body (30) that is inserted into a drug solution container (70), a connection port (15) to which a syringe (40) is connected, and a connector (50) that is connected to a port (110) of an infusion bag (100) communicate with a cavity (11) of a delivery device main body (10). A first check valve (21) that functions to permit the flow of drug solution toward the cavity from the drug solution flow path and restrict the flow of drug solution in the opposite direction is provided on a flow path between a drug solution flow path (31) of the cylindrical body and the cavity. A second check valve (22) that functions to permit the flow of drug solution toward the connector from the cavity and restrict the flow of drug solution in the opposite direction is provided on a flow path between the connector and the cavity. Drawing a plunger (45) of the syringe in and out enables a drug solution (72) contained in the drug solution container to be efficiently transferred to the infusion bag.

### TECHNICAL FIELD

The present invention relates to a drug solution delivery device for medical use that is used when transferring a drug solution contained in a drug solution container such as an ampoule or vial to an infusion bag.

### BACKGROUND ART

When administering a drug solution such as an anticancer drug contained in a drug solution container such as an ampoule or a vial into the patient's vein by intravenous drip, the drug solution contained in the drug solution container normally is transferred via a syringe to a large capacity infusion bag for preparation, before being administered. The drug solution is transferred by inserting a needle attached to the tip of the syringe into the drug solution container, aspirating the drug solution contained in the drug solution container into the syringe, and then sticking the needle into a rubber stopper of a port of the infusion bag, and injecting the drug solution into the infusion bag.

The amount of drug solution to be administered to the patient is determined based on the patient's weight, body surface area and the like. The required number of drug solution containers is determined according to the determined amount of drug solution. An operator has to transfer the drug solution contained in the required number of drug solution containers to the infusion bag. For example, in the case where the drug solution is an anticancer drug, it is not unusual for the number of drug solution containers to exceed ten.

In the case where a small capacity syringe is used for transferring the drug solution, the task of transferring the drug solution from the drug solution containers to the infusion bag is performed many times. That is, the needle attached to the tip of the syringe is alternately stuck into the drug solution containers and the rubber stopper many times, making the task of transferring the drug solution troublesome.

By using a large capacity syringe in the drug solution transfer to continuously aspirate the drug solution contained in the plurality of drug solution containers into the syringe and thereafter inject the drug solution collectively into the infusion bag, the number of times that the needle is alternately stuck into the drug solution containers and the rubber stopper can be reduced. However, it generally takes considerable force to draw the plunger in and out with a large capacity syringe, thus placing a significant physical load on the operator.

### CITATION LIST

### Patent Literature

Patent Literature 1: JP 2004-483A
Patent Literature 2: JP 2006-141714A
Patent Literature 3: JP 2007-267986A
Patent Literature 4: JP 3103389
Patent Literature 5: JP 8-506881A
Patent Literature 6: WO 2010/061742
Patent Literature 7: WO 2010/061743
Patent Literature 8: JP 3389983

### DISCLOSURE OF THE INVENTION

### Problem to be Solved by the Invention

An object of the present invention is to efficiently transfer a drug solution contained in a drug solution container to an infusion bag.

### Means for Solving the Problem

A drug solution delivery device for medical use of the present invention includes a cylindrical body that is provided with a drug solution flow path and is adapted to be inserted into a drug solution container, a connection port that is adapted to be connected to a syringe, a connector that is adapted to be connected to a port of an infusion bag, a delivery device main body inside which is formed a cavity that communicates with the drug solution flow path, the connection port and the connector, a first check valve that is provided on a flow path between the drug solution flow path and the cavity, and functions to permit a flow of drug solution toward the cavity from the drug solution flow path and restrict a flow of drug solution in an opposite direction, and a second check valve that is provided on a flow path between the connector and the cavity, and functions to permit a flow of drug solution toward the connector from the cavity and restrict a flow of drug solution in an opposite direction.

### Effects of the Invention

According to the present invention, the task of sticking a needle at the tip of a syringe alternately into a drug solution container and a rubber stopper of an infusion bag, as was conventionally the case, is not necessary, thus enabling the drug solution contained in the drug solution container to be efficiently transferred to the infusion bag.

### BRIEF DESCRIPTION OF DRAWINGS

FIG. 1 is a cross-sectional view showing a schematic configuration of a drug solution delivery device for medical use according to Embodiment 1 of the present invention.

FIG. 2 is a cross-sectional view showing a schematic configuration of a drug solution delivery device for medical use according to Embodiment 2 of the present invention.

FIG. 3A is a cross-sectional view showing a schematic configuration of a bottle needle before being stuck into the vial, and the periphery thereof in a drug solution delivery device for medical use according to Embodiment 3 of the present invention, and FIG. 3B is a cross-sectional view showing a schematic configuration of the bottle needle after being stuck into the vial, and the periphery thereof.

FIG. 4 is a cross-sectional view showing an alternative connector constituting a drug solution delivery device for medical use according to the present invention.

### DESCRIPTION OF THE INVENTION

In the drug solution delivery device for medical use of the present invention, preferably the cylindrical body is held in the delivery device main body and the connection port is provided in the delivery device main body. This enables the syringe, the delivery device main body and the cylindrical body to be treated (handled) as one. Accordingly, in the case where the cylindrical body is a cannula, for example, the operation of drawing the plunger of the syringe in and out with the cannula inserted in an ampoule can be performed easily. Also, in the case where the cylindrical body is a bottle needle, for example, operations such as drawing the plunger of the syringe in and out while lifting up the vial with the bottle needle stuck in the rubber stopper of the vial can be performed easily.

Preferably the syringe is disposed coaxially with the cylindrical body. Thereby, in the case where the cylindrical body is a cannula, for example, maintaining the position and posture of the cannula when the plunger of the syringe is drawn in and out is facilitated. Also, in the case where the cylindrical body is a bottle needle, for example, the task of sticking the bottle needle into the rubber stopper of the vial can be performed with substantially the same feel as the task of sticking a bottle needle attached to the tip of a syringe into a rubber stopper of a vial as conventionally performed.

Preferably a male screw that is adapted to screw into a female screw formed in a lock portion that surrounds a male luer that is at the tip of the syringe is formed in the connection port. In a drug solution delivery device for medical use in which the connection port and the syringe are separable, the possibility of the drug solution leaking at the connection portion of the connection port and the syringe thereby can be reduced.

Preferably the connector is connected to the delivery device main body via a tube that has pliability. The task of transferring the drug solution can thereby be performed with the infusion bag to which the connector is connected disposed in an arbitrary position. Also, the position and posture of the drug solution container, the syringe and the like can be changed freely during the transfer operation.

Preferably the connector is provided with a tubular body that is insertable into a slit of a septum provided in the port of the infusion bag. The connector thereby can be repeatedly inserted into and removed from the port. Also, because a metal needle is not used for the connector, coring can be prevented. Here, “coring” refers to the material of the rubber stopper getting shaved off by a sharp metal needle and entering the metal needle, and also getting mixed in the drug solution.

In the above, preferably the connector is further provided with a tubular body shield that has flexibility and covers at least a tip of the tubular body. In this case, preferably a slit is formed in a portion of the tubular body shield that opposes the tip of the tubular body. The possibility of the drug solution leaking from the tubular body of the connector when the connector is not connected to the port of the infusion bag can thereby be reduced.

Preferably the connector is provided with an elastically displaceable lock lever having an engaging claw that is adapted to engage the port of the infusion bag. The connected state of the port and the connector can thereby be stably maintained. Accordingly, the possibility of separation of the connector from the port as a result of external force or the like being applied, for example, and the drug solution leaking can be reduced.

Preferably at least one of the first check valve and the second check valve is a duckbill check valve. More preferably both the first check valve and the second check valve are duckbill check valves. Use of duckbill check valves enables a compact drug solution delivery device for medical use to be realized.

The outer cylinder of the syringe may be provided integrally with the connection port. The possibility of the drug solution leaking from the connection portion of the connection port and the outer cylinder can thereby be reduced.

The cylindrical body may be a cannula inserted in an ampoule serving as the drug solution container. According to this, the task of sticking a metal needle at the tip of a syringe alternately into an ampoule and a rubber stopper of an infusion bag, as was conventionally the case, is not necessary, and thus the drug solution contained in the ampoule can be efficiently transferred to the infusion bag. Also, a metal needle provided with a sharp tip is not used as the cylindrical body, thus preventing accidental puncturing or coring with a metal needle. Accordingly, the drug solution contained in the ampoule can be safely transferred to the infusion bag.

Preferably the cannula has pliability. Arbitrarily deforming the cannula inside the ampoule and completely aspirating the drug solution inside the ampoule thereby will be facilitated. Also, the possibility of the cannula hitting against and knocking over the ampoule and the drug solution spilling, when the plunger of the syringe is drawn in and out, can be reduced.

Alternatively, the cylindrical body may be a bottle needle that is stuck into the rubber stopper of the vial serving as the drug solution container. In this case, preferably the bottle needle is provided with a gas flow path in addition to the drug solution flow path. Preferably, when the bottle needle is stuck in the rubber stopper of the vial, the drug solution flow path and the inside of the vial communicate, and the inside of the vial and the outside communicate via the gas flow path. According to this, the task of sticking a bottle needle at the tip of a syringe alternately into a vial and an infusion bag, as was conventionally the case, is not necessary, thus the drug solution contained in the vial can be efficiently transferred to the infusion bag.

Preferably a third check valve that functions to permit the flow of gas toward the gas flow path from the outside and restrict the flow of drug solution in the opposite direction is provided between the gas flow path and the outside. The possibility of drug solution that passes along the gas flow path leaking out to the outside can thereby be reduced.

Preferably the third check valve is a duckbill check valve. Use of a duckbill check valve enables a compact drug solution delivery device for medical use to be realized.

Preferably a hydrophobic filter that allows passage of gas and substantially does not allow passage of drug solution is provided between the gas flow path and the outside. The possibility of drug solution that passes along the gas flow path leaking out to the outside can thereby be reduced.

Preferably a bottle needle shield that has flexibility and covers at least a tip of the bottle needle is further provided. In this case, preferably a slit is formed in a portion of the bottle needle shield that opposes the tip of the bottle needle. The possibility of the drug solution leaking out from the bottle needle to the outside when the bottle needle is not stuck in the vial can thereby be reduced.

The bottle needle may be divided into a needle for drug solution and a needle for gas that are mutually independent and respectively provided with the drug solution flow path and the gas flow path. In this case, the needle for drug solution and the needle for gas are each stuck into the rubber stopper of the vial. Use of the two needles for drug solution and for gas enables needle design and manufacture to be facilitated.

Hereinafter, the present invention will be described in detail by way of illustrative embodiments. It should, however, be obvious that the present invention is not limited to the following embodiments. For convenience of description, the diagrams referred to in the following description illustrate in simplified form only principal members required in order to describe the present invention, among the constituent members of the above embodiments of the present invention. Accordingly, the present invention can be provided with arbitrary members that are not shown in the following diagrams. Also, the dimensions in the following diagrams do not faithfully represent actual dimensions, proportions, or the like.

### Embodiment 1

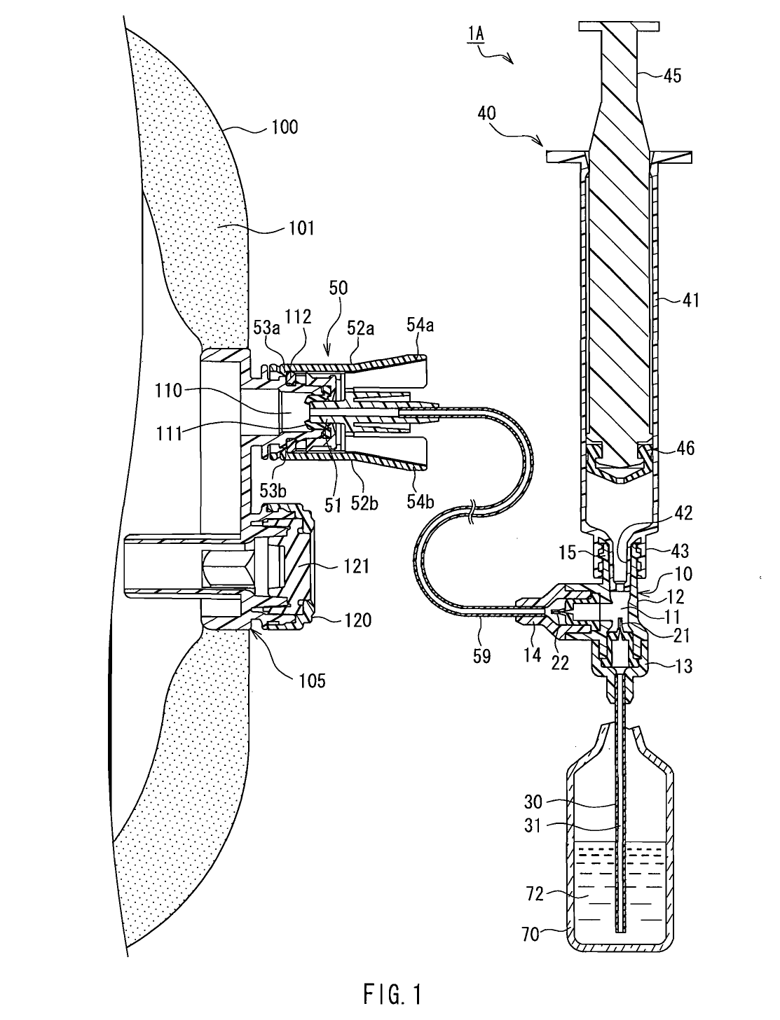

FIG. 1 is a cross-sectional view showing a schematic configuration of a drug solution delivery device 1A for medical use according to Embodiment 1 of the present invention. The drug solution delivery device a for medical use of the present Embodiment 1 is suitable for transferring a drug solution 72 contained in an ampoule 70 to an infusion bag 100.

The drug solution delivery device 1A for medical use is provided with a delivery device main body 10 inside which a cavity 11 and three flow paths that communicate with the cavity 11 are formed. One of the three flow paths allows communication between the cavity 11 and a cannula 30 serving as the cylindrical body that is inserted into the ampoule 70, another of the flow paths allows communication between the cavity 11 and a syringe 40, and the remaining flow path allows communication between the cavity 11 and a connector 50.

The delivery device main body 10 includes a branch pipe 12 that connects the three flow paths communicating with the cavity 11 in an approximate T-shape. A first cap 13 is mounted to a first opening of the branch pipe 12, a second cap 14 is mounted to a second opening, and the syringe 40 is connected to a third opening. The materials of the branch pipe 12, the first cap 13 and the second cap 14 constituting the delivery device main body 10 are not particularly restricted, and resins can be used, for example, with specific examples including resins that are considered to form a substantially rigid body such as polypropylene and polycarbonate.

A first check valve 21 is provided on the flow path between a drug solution flow path 31 of the cannula 30 and the cavity 11. The first check valve 21 is supported between the first cap 13 and the branch pipe 12. Also, a second check valve 22 is provided on the flow path between the connector 50 and the cavity 11. The second check valve 22 is supported between the second cap 14 and the branch pipe 12.

The cannula 30 is held in a tip of the first cap 13. The cannula 30 is a tube for aspirating the drug solution 72 contained in the ampoule 70 toward the cavity 11 while being inserted in the ampoule 70 serving as the drug solution container. The drug solution flow path 31 is formed in the longitudinal direction of the cannula 30, and the drug solution 72 flows along this drug solution flow path 31. Preferably the cannula 30 has pliability and is elastically deformable. When the cannula 30 has pliability, the cannula 30 can be arbitrarily deformed inside the ampoule 70, thus facilitating the complete aspiration of the drug solution 72 contained in the ampoule 70 by allowing the tip of the cannula 30 to be brought in contact with the inner surface of the ampoule 70. Also, the chance of the cannula 30 hitting against the ampoule 70 and knocking the ampoule 70 over at times such as when a plunger 45 of the syringe 40 is drawn in and out can be reduced. The material of the cannula 30 is not particularly restricted, and a resin can be used, for example, with specific examples including polyurethane and polyethylene. Although the dimensions of the cannula 30 also are not particularly restricted, preferably the outer diameter is 1 to 4 mm and the inner diameter is 0.3 to 3 mm.

One end of a tube 59 is connected at the tip of the second cap 14, and the other end of the tube 59 is connected to the connector 50.

Preferably the tube 59 has pliability and is transparent or translucent. The material of the tube 59 is not particularly restricted, and a resin can be used, for example, with specific examples including polyvinyl chloride, polybutadiene, and polyethylene.

The infusion bag 100 (only a portion thereof is shown in FIG. 1) is a sac-like structure that is formed by overlaying two pliable transparent resin sheets of the same dimensions one on the other and joining (e.g., heat sealing) the resin sheets at a sealing area 101 around the periphery thereof. A port main body 105 that includes a port 110 and an auxiliary port 120 is attached to the infusion bag 100 in a state of being sandwiched between the two resin sheets.

In the present Embodiment 1, the port 110 is a so-called needle-free port that is provided with a discoid rubber valve body (generally called a “septum”) 111 in which a linear slit (cut) is formed in a central portion. An outer periphery of the port 110 is a cylindrical surface, and an annular projection 112 that is continuous in the circumferential direction is formed on this outer periphery. The connector 50 connects to the port 110.

The connector 50 is provided with a tubular body 51 that is inserted into the slit of the septum 111. The tubular body 51 is in communication with the tube 59. The connector 50 is further provided with a pair of elastically swingable lock levers 52a and 52b that are disposed sandwiching the tubular body 51. Latching claws 53a and 53b are formed on opposing surfaces of the tips of the lock levers 52a and 52b. The material of the connector 50 is not particularly restricted, and a resin can be used, for example, with specific examples including polypropylene and polycarbonate.

When the connector 50 is pushed into the port 110, the tubular body 51 is inserted into the slit of the septum 111, and the annular projection 112 and the latching claws 53a and 53b engage (locked state), as shown in FIG. 1. Accordingly, the state where the tubular body 51 is inserted into the slit of the septum 111 can be maintained stably.

When operating portions 54a and 54b at the opposite end of the lock levers 52a and 52b to the latching claws 53a and 53b are grasped so as to approach each other, the lock levers 52a and 52b pivot elastically and the engaged state of the annular projection 112 and the latching claws 53a and 53b is released. If the connector 50 is pulled out from the port 110 in this state, the tubular body 51 can be removed from the septum 111. The slit of the septum 111 immediately closes when the tubular body 51 is removed from the septum 111. The septum 111 thus has resealability, and the tubular body 51 can be repeatedly inserted and removed.

Configurations of the connector 50 provided with the elastically displaceable lock levers 52a and 52b having the engaging claws 53a and 53b that engage the annular projection 112 of the port 110, and the port 110 that is adaptable to this connector 50 are described in Patent Literatures 1 to 3, for example.

The syringe 40 is provided with an outer cylinder 41, the plunger 45 that is inserted into the outer cylinder 41 and can be drawn in and out relative to the outer cylinder 41, and a gasket 46 that is attached to a tip of the plunger 45. A male luer 42 and a lock portion 43 that surrounds the male luer 42 are provided at a tip of the outer cylinder 41. Preferably the outer periphery of the male luer 42 has a 6% taper that is in compliance with ISO 594-1. The syringe 40 and the branch pipe 12 are coupled by inserting the male luer 42 into the connection port 15 of the branch pipe 12, and screwing a male screw formed on the outer periphery of the connection port 15 of the branch pipe 12 into a female screw formed on the inner periphery of the lock portion 43. The possibility of the drug solution leaking at the connection portion of the connection port 15 and the male luer 42 can thereby be reduced. Preferably the inner periphery of the connection port 15 has a 6% taper that is in compliance with ISO 594-1, so as to be able to contact closely with the taper formed on the outer periphery of the male luer 42.

The first check valve 21 is provided on the flow path between the cannula 30 (in particular, the drug solution flow path 31 thereof) and the cavity 11, and functions to permit the flow of drug solution toward the cavity 11 from the cannula 30 and restrict (prevent) the flow of drug solution in the opposite direction. The second check valve 22 is provided on the flow path between the connector 50 and the cavity 11, and functions to permit the flow of drug solution toward the connector 50 from the cavity 11 and restrict (prevent) the flow of drug solution in the opposite direction. In the present Embodiment 1, so-called duckbill check valves that are provided with a pair of lips composed of an elastic material (e.g., silicon rubber, polyisoprene rubber) are used as the first check valve 21 and the second check valve 22. Duckbill check valves are described in Patent Literatures 4 and 5, for example.

An exemplary method of transferring the drug solution 72 contained in the ampoule 70 to the infusion bag 100 using the drug solution delivery device 1A for medical use of the present Embodiment 1 constituted as described above will be described hereinafter.

Initially, as shown in FIG. 1, the syringe 40 is connected to the connection port 15, and the connector 50 is connected to the port 110 of an empty infusion bag 100. Next, the ampoule 70 is opened, the cannula 30 is inserted into the ampoule 70, and the tip of the cannula 30 is immersed in the drug solution 72 contained in the ampoule 70. At this time, the plunger 45 of the syringe 40 is in a state of being pushed right into the outer cylinder 41.

Next, the plunger 45 of the syringe 40 is pulled out. The drug solution 72 contained in the ampoule 70 flows through the drug solution flow path 31 of the cannula 30, the first check valve 21 and the cavity 11 in this order, and is drawn into the syringe 40.

Next, the plunger 45 of the syringe 40 is pushed in. The drug solution contained in the syringe 40 flows into the cavity 11 in the opposite direction to the above. The first check valve 21, however, restricts the flow of drug solution from the cavity 11 into the cannula 30. Accordingly, the drug solution flows from the cavity 11 through the second check valve 22, the tube 59, the connector 50 and the port 110 in this order, and flows into the infusion bag 100.

The plunger 45 is repeatedly drawn in and out if needed, and all of the drug solution 72 contained in the ampoule 70 is transferred to the infusion bag 100. The second check valve 22 restricts the flow of drug solution from the tube 59 to the cavity 11, thus ensuring that the drug solution contained in the tube 59 and the infusion bag 100 does not flow back into the cavity 11 or the syringe 40 through the second check valve 22 when the plunger 45 is pulled out.

In the case of transferring the drug solution contained in a plurality of ampoules 70 to a common infusion bag 100, the empty ampoule 70 is exchanged for a new ampoule 70, and the above operations are repeated. Thereafter, the port 110 and the connector 50 are separated.

The liquid substance (infusion solution) to be administered to the patient is prepared by injecting glucose solution, saline solution or the like into the infusion bag 100 if needed. This injecting operation may be performed using the drug solution delivery device 1A for medical use of the present Embodiment 1, or may be performed using another instrument.

Next, an infusion set (not shown) is connected to the infusion bag 100. The method of connecting the infusion bag 100 and the infusion set can be appropriately selected according to factors such as the configuration of the infusion set. For example, a metal needle provided at the upstream end of the infusion set may be stuck into a rubber stopper 121 provided in the auxiliary port 120 of the infusion bag 100. Alternatively, depending on the configuration of the infusion set, the upstream end of the infusion set may be connected to the port 110 to which the connector 50 had been connected, rather than to the auxiliary port 120.

Next, the metal needle at the downstream end of the infusion set is stuck into a vein of the patient. The infusion bag 100 is hung on an irrigator stand, and the infusion solution in the infusion bag 100 is administered to the patient via the infusion set.

As mentioned above, the drug solution delivery device 1A for medical use of the present Embodiment 1 enables the drug solution 72 contained in the ampoule 70 to be transferred to the infusion bag 100 simply by drawing the plunger 45 of the syringe 40 in and out in a state where the tip of the cannula 30 is immersed in the drug solution 72 contained in the ampoule 70. Accordingly, the task of sticking a metal needle at the tip of a syringe alternately into an ampoule and a rubber stopper of an infusion bag, as was conventionally the case, is not necessary. Accordingly, the task of transferring a drug solution is easy even in the case of transferring the drug solution contained in a plurality of ampoules 70 to the infusion bag 100, and the time taken to perform the transfer also can shortened.

Accordingly, the drug solution delivery device 1A for medical use of the present Embodiment 1 enables the drug solution 72 contained in the ampoule 70 to be efficiently transferred to the infusion bag 100.

With conventional methods of transferring a drug solution, there was a chance that the drug solution would leak out from the tip of the metal needle of the syringe before the metal needle was stuck into the rubber stopper of the infusion bag after aspirating the drug solution contained in the ampoule into the syringe. For example, some anticancer drugs are designated as dangerous drugs, and there was a risk that such drug solutions could accidentally adhere to the operator's fingers or the like.

In contrast, the drug solution delivery device 1A for medical use of the present Embodiment 1 enables the cannula 30 to remain inserted in the ampoule 70 until the ampoule 70 is empty, even in the case where the capacity of the syringe 40 is relatively small. Accordingly, there is little possibility of the drug solution leaking out from the tip of the cannula 30.

By repeatedly drawing the plunger 45 of the syringe 40 in and out several times in a state where the cannula 30 is inserted into the ampoule 70, the drug solution that is in the drug solution flow path 31 of the cannula 30 can be passed through the first check valve 21 and moved to the cavity 11 side. In the case of repeatedly transferring the drug solution contained in a plurality of ampoules 70 to the infusion bag 100, preferably the cannula 30 is removed from the empty ampoule 70 and inserted into the new ampoule 70, after a state where there is no drug solution in the drug solution flow path 31 of the cannula 30 has thus been achieved. The risk of drug solution leaking out from the tip of the cannula 30 and adhering to the operator's fingers or the like can thereby be reduced.

Also, even supposing that the plunger 45 is pushed in when there is still drug solution in the drug solution flow path 31, the first check valve 21 prevents backflow of the drug solution that is in the drug solution flow path 31. Accordingly, even in such a case, there is little risk of the drug solution leaking out from the tip of the cannula 30 and adhering to the operator's fingers or the like.

The drug solution delivery device 1A for medical use of the present Embodiment 1 is thus extremely safe, with there being little possibility of the drug solution 72 leaking out to the outside during the task of transferring the drug solution 72. This is particularly effective in the case where the drug solution 72 includes anticancer drugs designated as dangerous drugs, for example.

The cannula 30 is used only to aspirate drug solution by being inserted into the ampoule 70. Accordingly, the tip of the cannula 30 does not need to be sharp, and can be formed with a pliable material. That is, with the drug solution delivery device 1A for medical use of the present Embodiment 1, a metal needle with a sharp tip is not necessary.

Because a metal needle formed with a sharp tip is attached to the syringe used in the task of transferring a drug solution as conventionally performed, in order to puncture the rubber stopper of the port of the infusion bag, there was a risk of the operator accidentally pricking his or her finger or the like with the metal needle. In the present Embodiment 1, a metal needle is not necessary, thus solving this problem of accidental pricking with a metal needle during the task of transferring a drug solution as conventionally performed.

Also, in the task of transferring a drug solution as conventionally performed, when sticking a metal needle into the rubber stopper of an infusion bag, there was a risk of the material of the rubber stopper getting shaved off by the sharp metal needle (called “coring”) and entering the metal needle, and also getting mixed in the drug solution. In the present Embodiment 1, a metal needle is not necessary, thus solving the problem of coring that occurred with the task of transferring a drug solution as conventionally performed.

Accordingly, the drug solution delivery device 1A for medical use of the present Embodiment 1 enables the drug solution 72 contained in the ampoule 70 to be efficiently and safely transferred to the infusion bag 100.

In the above Embodiment 1, the cannula 30 and the syringe 40 are directly connected to the delivery device main body 10. The cannula 30, the delivery device main body 10 and the syringe 40 thereby can be handled as one. Accordingly, the plunger 45 can be easily drawn in and out with the cannula 30 inserted in the ampoule 70 while holding the syringe 40 with both hands, for example.

Also, the cannula 30 and the syringe 40 are disposed coaxially. Accordingly, maintaining the position and posture of the cannula 30 when drawing the plunger 45 of the syringe 40 in and out is facilitated.

On the other hand, because the connector 50 is connected to the delivery device main body 10 via the pliable tube 59, the task of transferring the drug solution can be performed with the infusion bag 100 to which the connector 50 is connected disposed in an arbitrary position. Also, the position and posture of the ampoule 70, the syringe 40 and the like can be freely changed during the transfer operation, thus enabling the transfer operation to be efficiently performed.

### Embodiment 2

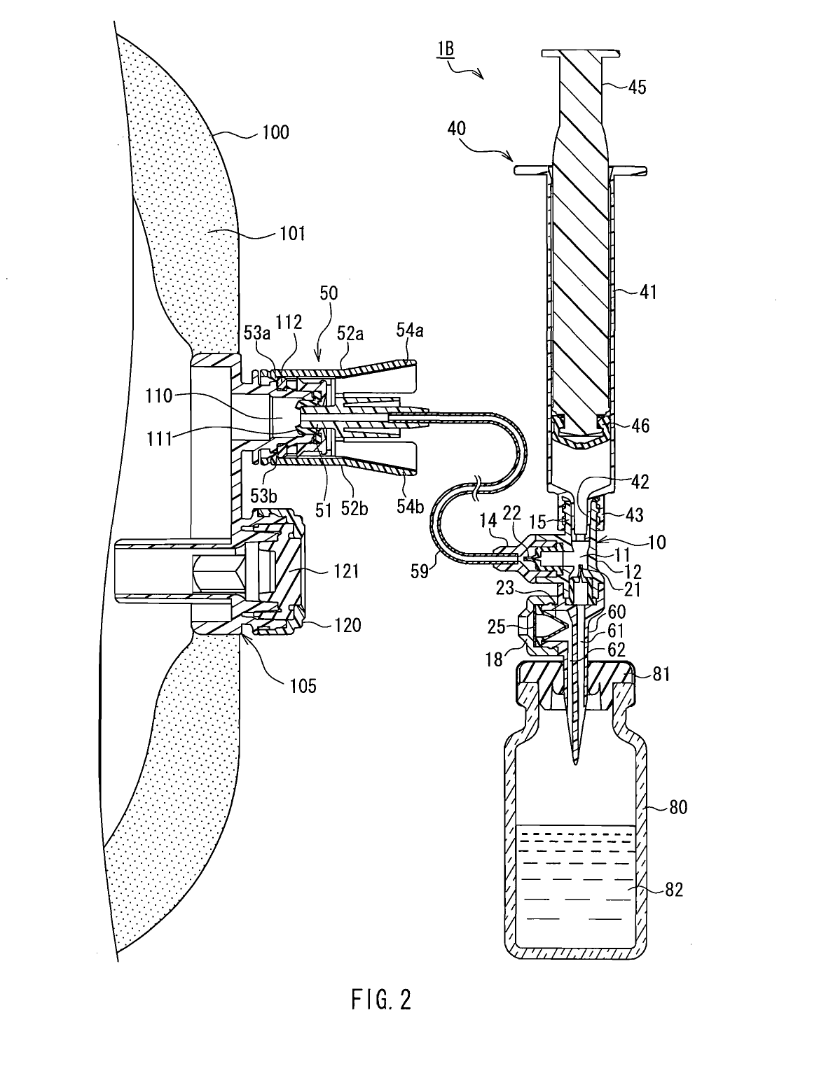

FIG. 2 is a cross-sectional view showing a schematic configuration of a drug solution delivery device 1B for medical use according to Embodiment 2 of the present invention. The drug solution delivery device 1B for medical use of the present Embodiment 2 is suitable for transferring a drug solution 82 contained in a vial 80 to an infusion bag 100.

The drug solution delivery device 1B for medical use is provided with a delivery device main body 10 inside which a cavity 11 and three flow paths communicating with the cavity 11 are formed. One of the three flow paths allows communication between the cavity 11 and a drug solution flow path 61 of a bottle needle 60 serving as the cylindrical body, another of the flow paths allows communication between the cavity 11 and a syringe 40, and the remaining flow path allows communication between the cavity 11 and a connector 50.

The delivery device main body 10 includes a branch pipe 12 that connects the three flow paths communicating with the cavity 11 in an approximate T-shape. The bottle needle 60 is mounted to a first opening of the branch pipe 12, a cap 14 is mounted to a second opening, and the syringe 40 is connected to a third opening. The materials of the branch pipe 12 and the cap 14 that constitute the delivery device main body 10 are not particularly restricted, and resins can be used, for example, with specific examples including the resins that are considered to form a substantially rigid body such as polypropylene and polycarbonate.

A first check valve 21 is provided on the flow path between the drug solution flow path 61 and the cavity 11. The first check valve 21 is supported between the bottle needle 60 and the branch pipe 12. Also, a second check valve 22 is provided on the flow path between the connector 50 and the cavity 11. The second check valve 22 is supported between the cap 14 and the branch pipe 12.

The bottle needle 60 is stuck into a rubber stopper 81 of the vial 80 serving as the drug solution container as shown in FIG. 2. The drug solution flow path 61 and a gas flow path 62 that are mutually independent are formed in the bottle needle 60. The drug solution flow path 61 communicates with the inside of the vial 80 when the bottle needle 60 is stuck in the rubber stopper 81 of the vial 80. The drug solution 82 contained in the vial 80 can thereby be allowed to flow into the cavity 11 through the drug solution flow path 61. Also, the gas flow path 62 allows communication between the inside of the vial 80 and the outside, when the bottle needle 60 is stuck in the rubber stopper 81 of the vial 80. Thereby, when the drug solution 82 contained in the vial 80 flows out through the drug solution flow path 61, air is allowed to flow into the vial 80 from the outside, preventing negative pressure from being created inside of the vial 80, and facilitating the outflow of the drug solution 82 from the vial 80. The bottle needle 60 has a sufficiently sharp tip and enough mechanical strength to puncture the rubber stopper 81. The material of the bottle needle 60 is not particularly restricted, and a resin material such as polycarbonate or polyacetal, for example, can be used. The respective cross-sections of the bottle needle 60, the drug solution flow path 61 and the gas flow path 62 can be arbitrary shapes such as circular or elliptical. Although the dimensions of the bottle needle 60 are not particularly restricted, the outer diameter preferably is 3 to 6 mm in the maximum diameter direction, the inner diameter of the drug solution flow path 61 preferably is 1 to 3 mm in the maximum diameter direction, and the inner diameter of the gas flow path 62 preferably is 0.5 to 2 mm in the maximum diameter direction.

A third check valve 23 and a hydrophobic filter 25 are provided in this order from the gas flow path 62 side, on the flow path between the gas flow path 62 and the outside. The third check valve 23 and the hydrophobic filter 25 are supported between a cap 18 and the bottle needle 60. The cap 18 has a through hole for allowing communication between the gas flow path 62 and the outside.

One end of the tube 59 is connected to a tip of the cap 14, and the other end of the tube 59 is connected to the connector 50.

Preferably the tube 59 has pliability and is transparent or translucent. The material of the tube 59 is not particularly restricted, and a resin can be used, for example, with specific examples including polyvinyl chloride, polybutadiene, and polyethylene.

The infusion bag 100 (only a portion thereof is shown in FIG. 2) is a sac-like structure that is formed by overlaying two pliable transparent resin sheets of the same dimensions one on the other and joining (e.g., heat sealing) the resin sheets at a sealing area 101 around the periphery thereof. A port main body 105 that includes a port 110 and an auxiliary port 120 is attached to the infusion bag 100 in a state of being sandwiched between the two resin sheets.

In the present Embodiment 2, the port 110 is a so-called needle-free port that is provided with a discoid rubber valve body (generally called a “septum”) 111 in which a linear slit (cut) is formed in a central portion. An outer periphery of the port 110 is a cylindrical surface, and an annular projection 112 that is continuous in the circumferential direction is formed on this outer periphery. The connector 50 connects to the port 110.

The connector 50 is provided with a tubular body 51 that is inserted into the slit of the septum 111. The tubular body 51 is in communication with the tube 59. The connector 50 is further provided with a pair of elastically swingable lock levers 52a and 52b that are disposed sandwiching the tubular body 51. Latching claws 53a and 53b are formed on opposing surfaces of the tips of the lock levers 52a and 52b. The material of the connector 50 is not particularly restricted, and a resin can be used, for example, with specific examples including polypropylene and polycarbonate.

When the connector 50 is pushed into the port 110, the tubular body 51 is inserted into the slit of the septum 111, and the annular projection 112 and the latching claws 53a and 53b engage (locked state), as shown in FIG. 2. Accordingly, the state where the tubular body 51 is inserted into the slit of the septum 111 can be stably maintained.

When operating portions 54a and 54b at the opposite end of the lock levers 52a and 52b to the latching claws 53a and 53b are grasped so as to approach each other, the lock levers 52a and 52b pivot elastically and the engaged state of the annular projection 112 and the latching claws 53a and 53b is released. If the connector 50 is pulled out from the port 110 in this state, the tubular body 51 can be removed from the septum 111. The slit of the septum 111 immediately closes when the tubular body 51 is removed from the septum 111. The septum 111 thus has resealability, and the tubular body 51 can be repeatedly inserted and removed.

Configurations of the connector 50 provided with the elastically displaceable lock levers 52a and 52b having the engaging claws 53a and 53b that engage the annular projection 112 of the port 110, and the port 110 that is adaptable to this connector 50 are described in Patent Literatures 1 to 3, for example.

The syringe 40 is provided with an outer cylinder 41, the plunger 45 that is inserted into the outer cylinder 41 and can be drawn in and out relative to the outer cylinder 41, and a gasket 46 that is attached to a tip of the plunger 45. A male luer 42 and a lock portion 43 that surrounds the male luer 42 are provided at a tip of the outer cylinder 41. Preferably the outer periphery of the male luer 42 has a 6% taper that is in compliance with ISO 594-1. The syringe 40 and the branch pipe 12 are coupled by inserting the male luer 42 into the connection port 15 of the branch pipe 12, and screwing a male screw formed on the outer periphery of the connection port 15 of the branch pipe 12 into a female screw formed on the inner periphery of the lock portion 43. The possibility of the drug solution leaking at the connection portion of the connection port 15 and the male luer 42 can thereby be reduced. Preferably the inner periphery of the connection port 15 has a 6% taper that is in compliance with ISO 594-1, so as to be able to contact closely with the taper formed on the outer periphery of the male luer 42.

The first check valve 21 is provided on the flow path between the drug solution flow path 61 and the cavity 11, and functions to permit the flow of drug solution toward the cavity 11 from the drug solution flow path 61 and restrict (prevent) the flow of drug solution in the opposite direction. The second check valve 22 is provided on the flow path between the connector 50 and the cavity 11, and functions to permit the flow of drug solution toward the connector 50 from the cavity 11 and restrict (prevent) the flow of drug solution in the opposite direction. The third check valve 23 is provided on the flow path between the gas flow path 62 and the outside, and functions to permit the flow of gas toward the gas flow path 62 from the outside and restrict (prevent) the flow of drug solution in the opposite direction. In the present Embodiment 2, so-called duckbill check valves that are provided with a pair of lips composed of an elastic material (e.g., silicon rubber, polyisoprene rubber) are used as the first check valve 21, the second check valve 22, and the third check valve 23. Duckbill check valves are described in Patent Literatures 4 and 5, for example.

The hydrophobic filter 25 is provided on the flow path between the gas flow path 62 and the outside. The hydrophobic filter 25 has hydrophobicity and air permeability and allows the passage of gas, but has the characteristic of substantially not allowing the passage of drug solution (liquid). The material of the hydrophobic filter 25 is not particularly restricted, and includes polytetrafluoroethylene (PTFE), polyolefin (polypropylene, polyethylene, etc.), polyvinylidene fluoride, for example. Preferably the hydrophobic filter 25 is a flat membrane filter such as a porous layer or a nonwoven fabric that use these materials.

An exemplary method of transferring the drug solution 82 contained in the vial 80 to the infusion bag 100 using the drug solution delivery device 1B for medical use of the present Embodiment 2 constituted as described above will be described hereinafter.

Initially, as shown in FIG. 2, the syringe 40 is connected to the connection port 15, and the connector 50 is connected to the port 110 of an empty infusion bag 100. Next, the bottle needle 60 is stuck into the rubber stopper 81 of the vial 80. At this time, the plunger 45 of the syringe 40 is in a state of being pushed right into the outer cylinder 41.

The vial 80 is placed at a higher position than the cavity 11, and the opening of the drug solution flow path 61 at the tip of the bottle needle 60 is immersed in the drug solution 82. Even if the drug solution 82 contained in the vial 80 happens to flow into the gas flow path 62 at this time, the third check valve 23 and the hydrophobic filter 25 prevent the outflow of the drug solution to the cap 18 side, thus ensuring that the drug solution 82 will not leak out to the outside. The plunger 45 of the syringe 40 is pulled out in this state. The drug solution 82 contained in the vial 80 flows through the drug solution flow path 61, the first check valve 21 and the cavity 11 in this order, and is drawn into the syringe 40. At this time, an amount of air corresponding to the amount of outflow of the drug solution 82 from the vial 80 flows into the vial 80 through the hydrophobic filter 25, the third check valve 23 and the gas flow path 62 in this order. Accordingly, negative pressure is not created inside of the vial 80.

Next, the plunger 45 of the syringe 40 is pushed in. The drug solution contained in the syringe 40 flows into the cavity 11 in the opposite direction to the above. The first check valve 21, however, restricts the flow of drug solution from the cavity 11 into the drug solution flow path 61. Accordingly, the drug solution flows from the cavity 11 through the second check valve 22, the tube 59, the connector 50 and the port 110 in this order, and flows into the infusion bag 100.

The plunger 45 is repeatedly drawn in and out if needed, and all of the drug solution 82 in the vial 80 is transferred to the infusion bag 100. The second check valve 22 restricts the flow of drug solution from the tube 59 to the cavity 11, thus ensuring that the drug solution contained in the tube 59 and the infusion bag 100 does not flow back into the cavity 11 or the syringe 40 through the second check valve 22 when the plunger 45 is pulled out.

In the case of transferring the drug solution contained in a plurality of vials 80 to a common infusion bag 100, the empty vial 80 is exchanged for a new vial 80, and the above operations are repeated. Thereafter, the port 110 and the connector 50 are separated.

The liquid substance (infusion solution) to be administered to the patient is prepared by injecting glucose solution, saline solution or the like into the infusion bag 100 if needed. This injecting operation may be performed using the drug solution delivery device 1B for medical use of the present Embodiment 2, or may be performed using another instrument.

Next, an infusion set (not shown) is connected to the infusion bag 100. The method of connecting the infusion bag 100 and the infusion set can be appropriately selected according to factors such as the configuration of the infusion set. For example, a metal needle provided at the upstream end of the infusion set may be stuck into a rubber stopper 121 provided in the auxiliary port 120 of the infusion bag 100. Alternatively, depending on the configuration of the infusion set, the upstream end of the infusion set may be connected to the port 110 to which the connector 50 had been connected, rather than to the auxiliary port 120.

Next, the metal needle at the downstream end of the infusion set is stuck into a vein of the patient. The infusion bag 100 is hung on an irrigator stand, and the infusion solution in the infusion bag 100 is administered to the patient via the infusion set.

As mentioned above, the drug solution delivery device 1B for medical use of the present Embodiment 2 enables the drug solution 82 contained in the vial 80 to be transferred to the infusion bag 100 simply by drawing the plunger 45 of the syringe 40 in and out in a state where the bottle needle 60 is stuck in the rubber stopper 81 in the vial 80. Accordingly, the task of sticking a bottle needle at the tip of a syringe alternately into a vial 80 and an infusion bag, as was conventionally the case, is not necessary. Accordingly, the task of transferring a drug solution is easy even in the case of transferring the drug solution 82 in a plurality of vials 80 to the infusion bag 100, and the time taken to perform the transfer can also shortened.

Accordingly, the drug solution delivery device 1B for medical use of the present Embodiment 2 enables the drug solution 82 contained in the vial 80 to be efficiently transferred to the infusion bag 100.

With conventional methods of transferring a drug solution, there was a chance that the drug solution would leak out from the tip of the bottle needle of the syringe before the bottle needle was stuck into the rubber stopper of the infusion bag after aspirating the drug solution contained in the vial into the syringe. For example, some anticancer drugs are designated as dangerous drugs, and there was a risk that such drug solutions could accidentally adhere to the operator's fingers or the like.

In contrast, the drug solution delivery device 1B for medical use of the present Embodiment 2 enables the bottle needle 60 to remain stuck in the rubber stopper 81 of the vial 80 until the vial 80 is empty, even in the case where the capacity of the syringe 40 is relatively small. Accordingly, there is little possibility of the drug solution leaking out from the tip of the bottle needle 60.

By repeatedly drawing the plunger 45 of the syringe 40 in and out several times in a state where the bottle needle 60 is stuck in the rubber stopper 81 of the vial 80, the drug solution that is in the drug solution flow path 61 can be passed through the first check valve 21 and moved to the cavity 11 side. In the case of repeatedly transferring the drug solution 82 in a plurality of vials 80 to the infusion bag 100, preferably the bottle needle 60 is removed from the empty vial 80 and inserted into the new vial 80, after a state where there is no drug solution in the drug solution flow path 61 has thus been achieved. The risk of drug solution leaking out from the tip of the bottle needle 60 and adhering to the operator's fingers or the like thereby can be reduced.

Also, even supposing that the plunger 45 is pushed in when there is still drug solution in the drug solution flow path 61, the first check valve 21 prevents backflow of the drug solution that is in the drug solution flow path 61. Accordingly, even in such a case, there is little risk of the drug solution leaking out from the tip of the bottle needle 60 and adhering to the operator's fingers or the like.

The drug solution delivery device 1B for medical use of the present Embodiment 2 is thus extremely safe, with there being little possibility of the drug solution 82 leaking out to the outside during the task of transferring the drug solution 82. This is particularly effective in the case where the drug solution 82 includes anticancer drugs designated as dangerous drugs, for example.

In the above Embodiment 2, the bottle needle 60 and the syringe 40 are directly connected to the delivery device main body 10. The bottle needle 60, the delivery device main body 10 and the syringe 40 thereby can be handled as one. Accordingly, the plunger 45 can be drawn in and out with the bottle needle 60 stuck in the rubber stopper 81 of the vial 80 while holding the syringe 40 with both hands and lifting up the vial 80, for example. That is, the task of transferring the drug solution can be performed with substantially the same feel as the task of transferring a drug solution as conventionally performed in which a drug solution contained in a vial is aspirated into a syringe via a bottle needle mounted at the tip of the syringe.

Also, the bottle needle 60 and the syringe 40 are disposed coaxially. Accordingly, the task of sticking the bottle needle 60 into the rubber stopper 81 of the vial 80 can also be performed with substantially the same feel as the task of transferring a drug solution as conventionally performed in which a bottle needle mounted at the tip of a syringe is stuck into the rubber stopper of a vial.

On the other hand, because the connector 50 is connected to the delivery device main body 10 via the pliable tube 59, the task of transferring the drug solution can be performed with the infusion bag 100 to which the connector 50 is connected disposed in an arbitrary position. Also, the position and posture of the vial 80, the syringe 40 and the like can be freely changed during the transfer operation, thus enabling the transfer operation to be efficiently performed.

### Embodiment 3

Hereafter, a drug solution delivery device 1B for medical use according to Embodiment 3 of the present invention will be described focusing on differences from Embodiment 2. In the diagrams referred to in the following description, the same reference signs are given to members that are the same as members shown in FIG. 2 referred to in Embodiment 2, and overlapping description thereof will be omitted.

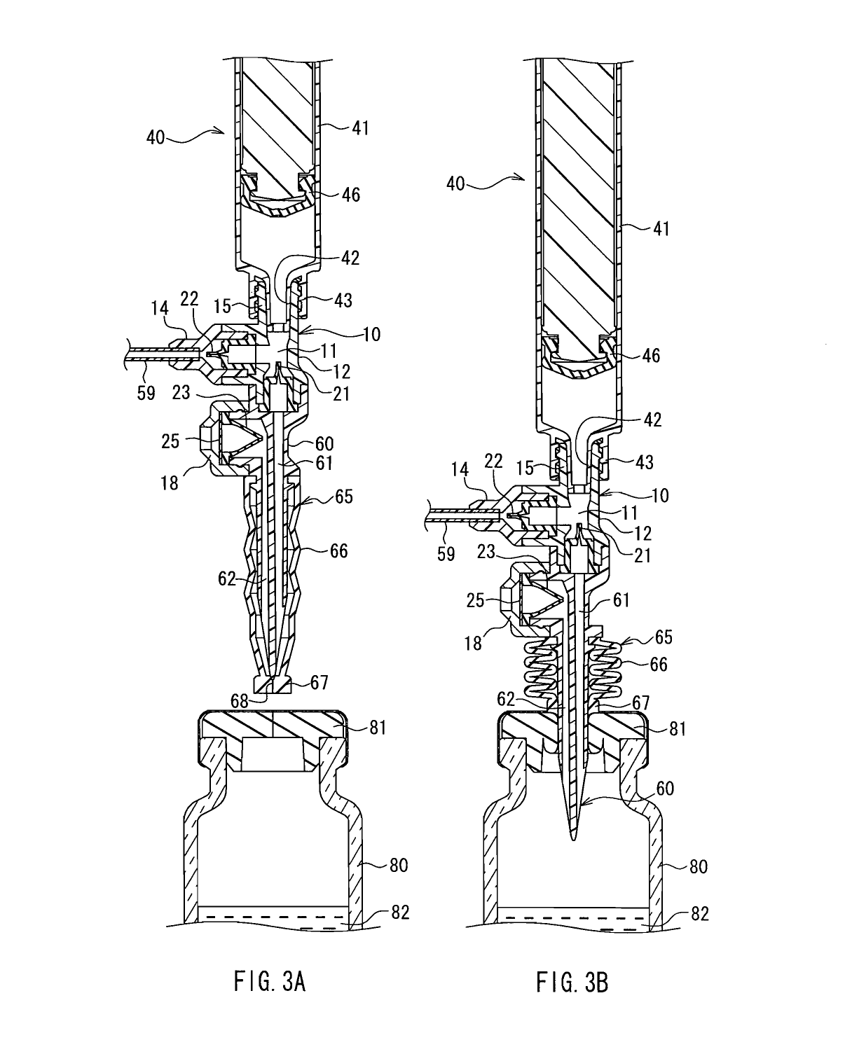

FIG. 3A is a cross-sectional view showing a schematic configuration of a bottle needle 60 before being stuck into a rubber stopper 81 of a vial 80, and the periphery thereof in the drug solution delivery device for medical use according to the present Embodiment 3. In the present Embodiment 3, a bottle needle shield 65 (hereinafter, simply “shield”) is provided to the bottle needle 60. The shield 65 is provided with an accordion cylindrical portion 66 and a shield plate 67 provided in one end of the cylindrical portion 66. The tip of the bottle needle 60 abuts or is proximal to the inner surface of the shield plate 67. A linear slit (cut) 68 is formed in a portion of the shield plate 67 that opposes the tip of the bottle needle 60. An end portion of the cylindrical portion 66 at the opposite end to the shield plate 67 is fixed to the bottle needle 60. The shield 65 covers the openings of a drug solution flow path 61 and a gas flow path 62 at the tip of the bottle needle 60 or in the vicinity thereof. The shield 65 is composed of a material (e.g., silicon rubber, polyisoprene rubber) that has flexibility (pliability).

The bottle needle 60 on which the shield 65 is mounted as described above is stuck into the rubber stopper 81 of the vial 80. FIG. 3B is a cross-sectional view showing a state where the bottle needle 60 has been stuck into the rubber stopper 81 of the vial 80. The tip of the bottle needle 60 has passed through the slit 68 of the shield plate 67, and is sticking in the rubber stopper 81 in a state where the shield plate 67 abuts the rubber stopper 81. The cylindrical portion 66 is elastically compression-deformed.

When the bottle needle 60 is pulled out from the rubber stopper 81, the cylindrical portion 66 extends due to elastic recovery force, the bottle needle 60 is removed through the slit 68, the slit 68 closes, and the initial state shown in FIG. 3A is restored.

The transfer of the drug solution 82 of the present Embodiment 3 is the same as that of Embodiment 2.

According to the present Embodiment 3, when the bottle needle 60 is not stuck in the vial 80, the tip of the bottle needle 60 and the vicinity thereof including the opening of the drug solution flow path 61 and the opening of the gas flow path 62 are covered with the shield 65 as shown in FIG. 3A. Accordingly, the possibility of the drug solution 82 leaking out from the bottle needle 60 to the outside can be reduced. Accordingly, safety can be further improved as compared with Embodiment 2.

The present Embodiment 3 is the same as Embodiment 2 except for the above, and achieves a similar effect to that described in Embodiment 2.

The above Embodiments 1 to 3 are merely illustrative, and the present invention is not limited thereto, and can be modified as appropriate.

For example, although a cylindrical body (i.e., cannula 30 or bottle needle 60) is held in the delivery device main body 10 in which the cavity 11 is formed in the above Embodiments 1 to 3, the present invention is not limited thereto. The delivery device main body 10 and the cylindrical body (cannula 30 or bottle needle 60) may be connected by a pliable tube, for example. Also, although the connection port 15 to which the syringe 40 is connected is provided in the delivery device main body 10 in the above Embodiments 1 to 3, the present invention is not limited thereto. For example, a pliable tube may be connected to the delivery device main body 10, and the terminal end of the tube may serve as the connection port 15 to which the syringe 40 is connected. Also, the connector 50 may be provided directly to the delivery device main body 10, rather than via the tube 59.

The configuration of the connection portion of the connection port 15 and the syringe 40 is not limited to the above Embodiments 1 to 3. For example, a luer lock mechanism for screwing together a male screw and a female screw such as the above Embodiments 1 to 3 need not be provided. The connection port 15 may be provided with a septum, and the cavity 11 and the syringe 40 may be communicated by inserting a male luer at the tip of the syringe 40 into a slit in the septum.

In the above Embodiments 1 to 3, the syringe 40 and the connection port 15 are separable. An optimal syringe 40 can thereby be selected according to the capacity of the drug solution container (i.e., ampoule 70 or vial 80), the type of drug solution or the like and connected to the connection port 15, every time the task of transferring a drug solution is performed. The present invention is not, however, limited thereto, and an integral structure may be formed by forming the outer cylinder 41 of the syringe 40 integrally with the connection port 15, for example. Leakage of drug solution from the connection portion of the connection port 15 and the syringe 40 can thereby be prevented.

Although duckbill check valves are used as the first check valve 21, the second check valve 22 and the third check valve 23 in the above Embodiments 1 to 3, the present invention is not limited thereto. As for the first check valve 21 and the second check valve 22, an arbitrary check valve that is able to permit the flow of drug solution in one direction and inhibit (prevent) the flow in the opposite direction can be used. Also, as for the third check valve 23, an arbitrary check valve that is able to permit the flow of gas in one direction and restrict (prevent) the flow of drug solution in the opposite direction can be used. An umbrella check valve, for example, can be used as the first check valve 21, the second check valve 22 and the third check valve 23. Also, at least one of the first check valve 21, the second check valve 22 and the third check valve 23 may be a different type of check valve from the others.

As long as the first check valve 21 is provided on the flow path of drug solution between the drug solution flow paths 31 and 61 and the cavity 11, the installation position thereof is not limited to the above Embodiments 1 to 3. Similarly, as long as the second check valve 22 is provided on the flow path of drug solution between the connector 50 and the cavity 11, the installation position thereof is not limited to the above Embodiments 1 to 3. For example, the second check valve 22 may be provided in the connector 50.

Although the third check valve 23 and the hydrophobic filter 25 are mounted to the bottle needle 60 in the above Embodiments 2 and 3, as long as the third check valve 23 and the hydrophobic filter 25 are provided on the flow path between the gas flow path 62 and the outside, the installation position thereof is not limited to the above Embodiments 2 and 3. For example, the gas flow path 62 of the bottle needle 60 may be connected to the third check valve 23 and the hydrophobic filter 25 by a pliable tube or the like. The hydrophobic filter 25 and the third check valve 23 may be disposed in this order from the gas flow path 62 side, opposite to that in the above Embodiments 2 and 3. One or both of the third check valve 23 and the hydrophobic filter 25 also may be omitted.

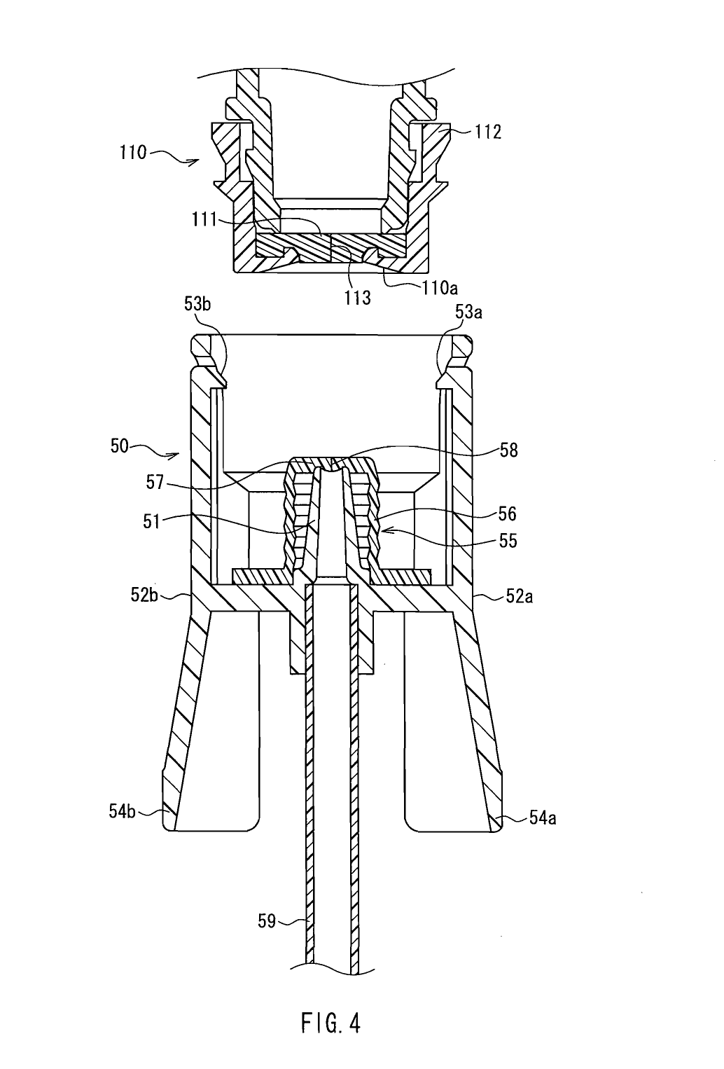

The configuration of the connector 50 is not limited to the above Embodiments 1 to 3. For example, the tip of the tubular body 51 may be covered with a tubular body shield 55 (hereinafter, simply “shield”), as shown in FIG. 4 (e.g., see Patent Literatures 6 and 7). The shield 55 is provided with an accordion cylindrical portion 56 and a shield plate 57 that is provided at one end of the cylindrical portion 56, similarly to the shield 65 described in Embodiment 3. The tip of the tubular body 51 is in close contact with the shield plate 57. A linear slit (cut) 58 is formed in a portion of the shield plate 57 that opposes the tip of the tubular body 51. The shield 55 is constituted by a material (e.g., silicon rubber, polyisoprene rubber) that has flexibility (pliability). When the connector 50 is pushed into the port 110, the shield plate 57 is pushed by a top surface 110a of the port 110, the cylindrical portion 56 undergoes elastic compression deformation, the tip of the tubular body 51 passes through the slit 58 and projects out therefrom, and the tubular body 51 is then inserted into a slit 113 of the septum 111. When the connector 50 is pulled out from the port 110, the tubular body 51 is removed from the septum 111, the cylindrical portion 56 elastically recovers and returns to the initial state shown in FIG. 4, and the slit 58 doses. By covering the tip of the tubular body 51 of the connector 50 with the shield 55 in which the slit 58 is formed, the possibility of the drug solution leaking from the tubular body 51 when the connector 50 is not connected to the port 110 thus can be reduced.

The configuration of the connector can be appropriately modified according to the configuration of the port 110 provided in the infusion bag 100. The lock mechanism for holding the state where the connector is connected to the port 110 is not limited to the lock levers 52a and 52b shown in the above Embodiments 1 to 3. For example, the connector may be a so-called revolving connector such as described in Patent Literature 8. The revolving connector has, surrounding the tubular body, a lock connector that is rotatable relative to the tubular body. The lock nut can be engaged with the port by rotating the lock nut with the tubular body being inserted in the slit of septum of the port.

The connector need not be provided with a lock mechanism that engages the port. For example, the connector may be constituted by only a tubular body that is insertable into the slit of the septum 111 of the port 110.

The port 110 provided in the infusion bag 100 need not be a needle-free port provided with the septum 111. The configuration of the port 110 is arbitrary and the configuration of the connector can be appropriately selected according to the configuration of the port 110.

The configuration of the infusion bag 100 is not particularly limited. The type of drug solution to be transferred is also not restricted.

In the above Embodiments 2 and 3, the mutually independent drug solution flow path 61 and gas flow path 62 are formed in a single bottle needle 60. This bottle needle 60 may be divided into a needle for drug solution and a needle for gas that are mutually independent and in which the drug solution flow path 61 and the gas flow path 62 are respectively formed. The drug solution needle and the gas needle are disposed approximately parallel to each other, and are each stuck into the rubber stopper of the vial. The drug solution needle and the gas needle can be manufactured using a resin material or a metal material.

### INDUSTRIAL APPLICABILITY

The use field of the present invention is not particularly restricted, and the present invention can be used in a wide range of fields as a drug solution delivery device for medical use that is used when transferring a drug solution contained in a drug solution container such as an ampoule or a vial to an infusion bag.

### LIST OF REFERENCE NUMERALS

1A, 1B drug solution delivery device for medical use
10 delivery device main body
11 cavity
15 connection port
21 first check valve
22 second check valve
23 third check valve
25 hydrophobic filter
30 cannula (cylindrical body)
31 drug solution flow path
40 syringe
41 outer cylinder
42 male luer
43 lock portion
45 plunger
50 connector
51 tubular body
52a, 52b lock lever
53a, 53b latching claw
55 tubular body shield
56 cylindrical portion
57 shield plate
58 slit
59 tube
60 bottle needle (cylindrical body)
61 drug solution flow path
62 gas flow path
65 bottle needle shield
66 cylindrical portion
67 shield plate
68 slit
70 ampoule (drug solution container)
72 drug solution
80 vial (drug solution container)
81 rubber stopper of vial
82 drug solution
100 infusion bag
110 port
111 septum
113 slit of septum

1. A drug solution delivery device for medical use comprising:
a cylindrical body that is provided with a drug solution flow path, and is adapted to be inserted into a drug solution container;
a connection port that is adapted to be connected to a syringe;
a connector that is adapted to be connected to a port of an infusion bag;
a delivery device main body inside which is formed a cavity that communicates with the drug solution flow path, the connection port and the connector;
a first check valve that is provided on a flow path between the drug solution flow path and the cavity, and functions to permit a flow of drug solution toward the cavity from the drug solution flow path and restrict a flow of drug solution in an opposite direction; and
a second check valve that is provided on a flow path between the connector and the cavity, and functions to permit a flow of drug solution toward the connector from the cavity and restrict a flow of drug solution in an opposite direction.

2. The drug solution delivery device for medical use according to claim 1, wherein the cylindrical body is held in the delivery device main body, and the connection port is provided in the delivery device main body.

3. The drug solution delivery device for medical use according to claim 1, wherein the syringe is disposed coaxially with the cylindrical body.

4. The drug solution delivery device for medical use according to claim 1, wherein a male screw that is adapted to screw into a female screw formed in a lock portion surrounding a male luer that is at a tip of the syringe is formed in the connection port.

5. The drug solution delivery device for medical use according to claim 1, wherein the connector is connected to the delivery device main body via a tube that has pliability.

6. The drug solution delivery device for medical use according to claim 1, wherein the connector is provided with a tubular body that is insertable into a slit of a septum provided in the port of the infusion bag.

7. The drug solution delivery device for medical use according to claim 6, wherein the connector is further provided with a tubular body shield that has flexibility and covers at least a tip of the tubular body, and a slit is formed in a portion of the tubular body shield that opposes the tip of the tubular body.

8. The drug solution delivery device for medical use according to claim 1, wherein the connector is provided with an elastically displaceable lock lever having an engaging claw that is adapted to engage the port of the infusion bag.

9. The drug solution delivery device for medical use according to claim 1, wherein at least one of the first check valve and the second check valve is a duckbill check valve.

10. The drug solution delivery device for medical use according to claim 1, wherein an outer cylinder of the syringe is provided integrally with the connection port.

11. The drug solution delivery device for medical use according to claim 1, wherein the cylindrical body is a cannula that is inserted into an ampoule serving as the drug solution container.

12. The drug solution delivery device for medical use according to claim 11, wherein the cannula has pliability.

13. The drug solution delivery device for medical use according to claim 1, wherein
the cylindrical body is a bottle needle that is stuck into a rubber stopper of a vial serving as the drug solution container,
the bottle needle is provided with a gas flow path in addition to the drug solution flow path, and
when the bottle needle is stuck in the rubber stopper of the vial, the drug solution flow path and the inside of the vial communicate, and the inside of the vial and the outside communicate via the gas flow path.

14. The drug solution delivery device for medical use according to claim 13, wherein a third check valve that functions to permit a flow of gas toward the gas flow path from the outside and restrict a flow of drug solution in an opposite direction is provided between the gas flow path and the outside.

15. The drug solution delivery device for medical use according to claim 14, wherein the third check valve is a duckbill check valve.

16. The drug solution delivery device for medical use according to claim 13, wherein a hydrophobic filter that allows passage of gas and substantially does not allow passage of drug solution is provided between the gas flow path and the outside.

17. The drug solution delivery device for medical use according to claim 13, further comprising a bottle needle shield that has flexibility and covers at least a tip of the bottle needle,
wherein a slit is formed in a portion of the bottle needle shield that opposes the tip of the bottle needle.

18. The drug solution delivery device for medical use according to claim 13, wherein the bottle needle is divided into a needle for drug solution and a needle for gas that are mutually independent and respectively provided with the drug solution flow path and the gas flow path.
